(19) United States
(12) Patent Application Publication
(10) Pub. No.: US 2004/0077214 A1
(43) Pub. Date: Apr. 22, 2004

(54) Electrical connection bulkhead header

(76) Inventors: James Turek, LaGrange, IL (US); Kenneth G. Irish, Chicago, IL (US)

Correspondence Address: Illinois Tool Works, Paul F. Donovan, Corporate Headquarters, 3600 W. Lake Avenue, Glenview, IL, 60025, US

(21) Appl. No.: 10/314,742

(22) Filed: Dec. 9, 2002

Related U.S. Application Data
(63) Continuation of application No. 60/341,528, filed on Dec. 17, 2001.

(51) Int. Cl. H01R 13/73

(52) U.S. Cl. 439/565

(57) ABSTRACT

A bulkhead header for electrically connecting electrical connectors on first and second sides of a bulkhead having first and second surfaces and defining an opening therein includes a body configured for insertion into the bulkhead opening. The header includes at least a pair of tangs for engaging the first surface of the bulkhead. A plurality of pins are disposed in the body and extend from a flange side of the header through to a body side of the header. A flange is formed integral with the body for resting against the second surface of the bulkhead. A portion of the bulkhead is engaged between the tangs and flange to secure the header to the bulkhead. The pins provide electrical connection across the first and second surfaces of the bulkhead.

### BACKGROUND OF THE INVENTION

The present invention is directed to an electrical connection bulkhead header. More particularly, the present invention pertains to an electrical connection bulkhead header for providing an electrical connection at a penetration in a bulkhead such as a wall.

It is known to feed wire harnesses through an opening or hole in a wall. In many such arrangements, the opening around the wire harness may be sealed with, for example, putty to provide an environmental seal around the wires. The terminal ends of the wires in the harness can terminate at an electrical connector or the like.

In one use, for example in refrigerated applications, the seal prevents the transfer of warm air to the refrigerated section. However, this arrangement does not allow for easy servicing of the unit or device inside of the refrigerated section, that is the unit or device to which the connector is connected.

Moreover, it has been found that such putty or putty-like formed seals can leak. As such, either conditioned air can escape the refrigerated section or conversely, warm air can enter the refrigerated section. Leakage of air can also result in the formation of condensation. Condensation can, in turn, cause corrosion or shorting and other problems with electrical devices, and can spread contamination by carrying bacteria and the like.

Accordingly, there exists a need for a header for performing electrical connections for use in applications that require some measure of environmental isolation. Desirably, such a header is adapted to fit into an aperture provided in a mating wall and permits the installation of electrical connectors on both sides of the header. More desirably, such a header fits into an opening in an internal wall of a refrigerated device such as a vending machine to provide electrical service to devices within the machine. Most desirably, such a header seals around the opening and includes an integral cover element for protecting the electrical terminals or pins of the header.

### BRIEF SUMMARY OF THE INVENTION

A bulkhead header provides for electrically connecting electrical connectors on first and second sides of a bulkhead. An exemplary bulkhead has inner and outer shells surrounding a core. The inner shell has first and second surfaces and defines an opening therein into which the header is inserted or installed. The outer shell may likewise include first and second surfaces having an opening therein.

The header includes a body that is configured for insertion into the bulkhead opening. At least a pair of tangs extend from the body for engaging the first surface of the bulkhead. A flange is formed integral with the body for resting against the second surface of the bulkhead such that a portion of the bulkhead is engaged between the tangs and flange to secure the header to the bulkhead.

A plurality of pins is disposed in the body. The pins extend from a flange side of the header through to a body side of the header. The pins provide electrical connection across the first and second surfaces of the bulkhead.

The header can include a cover connected to the flange for overlying the pins at the flange side of the header. A present header is formed as a unitary molded part with the cover integrally formed with the header and connected to the flange by a living hinge. Preferably, the cover includes a latch to secure the cover in a closed position overlying the pins at the flange side of the header. The cover serves as a drip shield and includes opposing side walls, a top wall and a rear wall. The hinge is disposed on the top wall and the latch is disposed one or both of the side walls.

In one embodiment, the tangs extend from an end of the body and are oriented outwardly and rearwardly toward the flange. In this arrangement, the tangs extend rearwardly toward the flange and are spaced from the flange a predetermined distance. The tangs spread (e.g., extend outwardly) to define an effective circumference that is greater than a distance across the body.

Alternately, the tangs extend from an end of the body and are oriented forwardly, away from the flange. In this arrangement, the tangs engage an opposite wall of the bulkhead. A tapered wall can be formed at a transition of the flange and the body to enhance the seal at the bulkhead opening.

Preferably, the body is formed to define a projecting region having a cavity therein. The projecting region is configured for insertion into the bulkhead opening, and the pins are set in the cavity.

One or more interference members can be formed on the body to permit connecting a connector to the pins in only one orientation. The interference member can be formed as one or more walls or a stub extending outward from the body adjacent the pins.

The pins can take many arrangements, such as ten pins arranged in a single row, or ten pins arranged in two rows of five pins each. In the two row configuration, the rows can be coplanar or they can be arranged in first and second non-planar planes. Of course, arrangements of other than ten pins can be used.

In a preferred arrangement, a seal or gasket is disposed on the flange to abut the bulkhead. The seal can be adhered to the flange by an adhesive.

These and other features and advantages of the present invention will be apparent from the following detailed description, in conjunction with the appended claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is a rear perspective view of an embodiment of an electrical connection bulkhead header embodying the principles of the present invention, the header being shown in an exploded relation to an opening in a device or bulkhead to which the header is mounted, and further being illustrated with a contact assembly or connector mounted therein and with an integral cover shown open;

FIG. 2 is a front perspective view of the header of FIG. 1;

FIG. 3 is another rear perspective view of the header of FIG. 1, looking upward into the rear of the header;

FIG. 4 is a rear perspective view of the header similar to FIG. 1, the header being illustrated with a connector mounted thereto having a plurality of wires extending from the connector;

FIG. 5 is a rear perspective view of the header of FIG. 1 shown with the cover closed;

FIG. 6 is front perspective view of another embodiment of an electrical connection bulkhead header in accordance with the principles of the present invention, the header being illustrated with the cover closed, this embodiment shown with a seal at the front face of the header;

FIG. 7 is a side view of the header of FIG. 6 illustrating the bulkhead latches and shown with a connector retainer or lock;

FIG. 8 is a front view of the header of FIG. 6;

FIG. 9 is a top view of the header of FIG. 6;

FIG. 10 is a rear perspective view of still another embodiment of the electrical connection bulkhead header in accordance with the present invention, the header being shown in an exploded relation to an opening in a device to which the header is mounted, and further being illustrated with a connector mounted therein and with an integral cover shown open;

FIG. 11 is a front perspective view of the header of FIG. 10;

FIG. 12 is a front perspective view of the header similar to FIG. 10, and illustrated with a connector and a plurality of wires extending from the connector;

FIG. 13 is a rear perspective view of yet another embodiment of the electrical connection bulkhead header in accordance with the present invention, the header being shown in an exploded relation to an opening in a device to which the header is mounted, and further being illustrated with a connector mounted therein and with an integral cover shown open; and

FIG. 14 is a side view of the header of FIG. 13 illustrated with the cover open and with a plurality of connectors mounted thereto and wires extending from the connectors.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description Of The Invention”, relates to a requirement of the United States Patent Office, and does not imply, nor should be inferred to limit the subject matter disclosed herein.

Referring now to the figures and in particular FIGS. 1-5, there is shown one embodiment of an electrical connection bulkhead header 10 that is used to provide a serviceable connection from one side of a bulkhead B to a device or unit on the other side of the bulkhead B. In an exemplary application, such a bulkhead header 10 is used to provide a connection from one side of a refrigerated device to the other side of a refrigerated device. For example, the bulkhead header 10 can be used to provide electrical connection from the outside of a refrigerated vending machine to the inside of a refrigerated vending machine. The header 10 is used to provide a readily serviceable connection to the inside components to permit readily disconnecting the component and reconnecting the component to effect maintenance, repair or replacement.

As illustrated in FIG. 1, the header 10 is configured to fit (e.g., to insert) into an opening O in the bulkhead B. In the illustration of FIG. 1, the bulkhead B is the wall of a vending machine, and the opening O in the bulkhead B is circular. For purposes of the present disclosure, the inside of the bulkhead B, as indicated generally at I, is within the refrigerated or conditioned environment and the outside of the bulkhead B, as indicated generally at E, is at local environmental conditions.

A typical bulkhead B is formed from an inner shell or skin 12, a core 14 that may be formed from an insulating material, such as an insulating foam, and an outer shell or skin 16. The inner and outer shells 12, 16 can be a metal, for example, steel, or a like rigid material. Each the inner and outer shells 12, 16 have inner 18, 20 and outer 22, 24 surfaces, respectively. The inner surfaces 18, 20 of both shells 12, 16 are those surfaces adjacent the inner core 14 and the outer surfaces 22, 24 of the shells 12, 16 are at the inner and outer surfaces of the bulkhead B, respectively.

The header 10 includes a body 26, a flange 28, a cover 30 and a plurality of electrical connection pins 32. The body 26 is configured for insertion into the bulkhead opening O, and includes at least one, and preferably a pair of resilient, flexible tangs 34 that extend outwardly from the body 26 for engaging one of the shells 12, 16. In one embodiment, the tangs 34 are configured to engage the inner surface 18 of the inner shell 12.

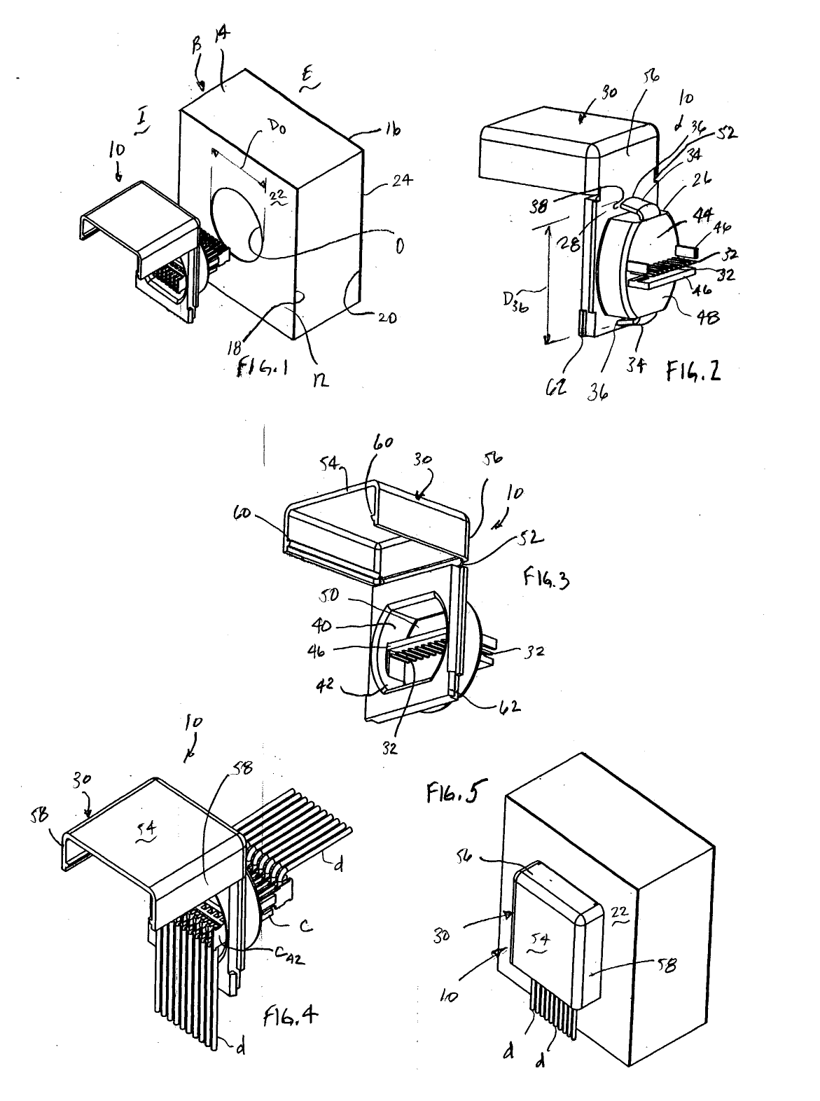

The flange 28 resides at a front end of the body 26 and is adapted to engage or abut the outer surface 22 of the bulkhead inner shell 12. In this manner, when the header 10 is inserted into the opening O, the tangs 34 engage the inner shell inner surface 18, while the flange 28 lies adjacent the inner shell outer surface 22. As seen in FIG. 2, the tangs 34 extend from an end of the body 26, outwardly and rearwardly toward the flange 28.

The tangs 34, as they extend outwardly, each terminate at a free end 36 that is spaced from the flange 28. The radial distance D₃₆ between the tang free ends 36 (i.e., across the diameter of the body 26), is greater than the diameter Do of the opening O into which the body 26 is inserted. That is, the ends 36 of the tangs 34 define an effective circumference (greater than a circumference or size of the body 26 and the bulkhead shell opening O) for locking the header 10 onto the inner shell 12. The space (indicated at 38) between the tang ends 36 and the flange 28 is sufficient to provide a snug fit of the shell 12 between the tangs 34 and the flange 28. As such, the tangs 34 engage the inner shell inner surface 18 and the flange 28 abuts the inner shell outer surface 22 to essentially sandwich the shell 12 between the tangs 34 and the flange 28 to secure the header 10 to the bulkhead inner shell 12.

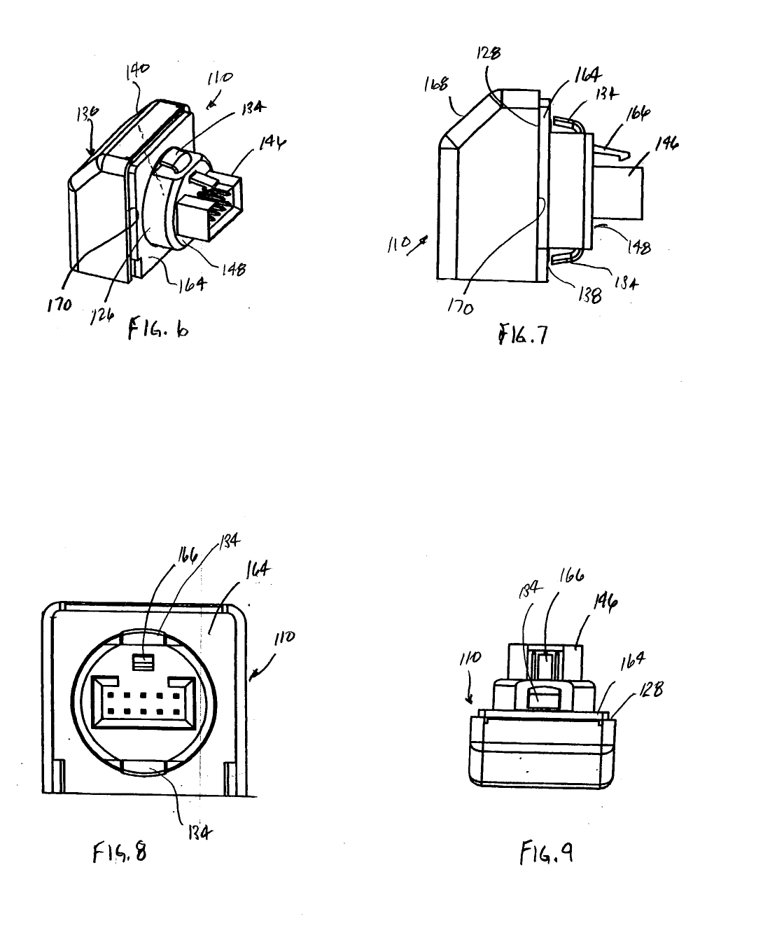

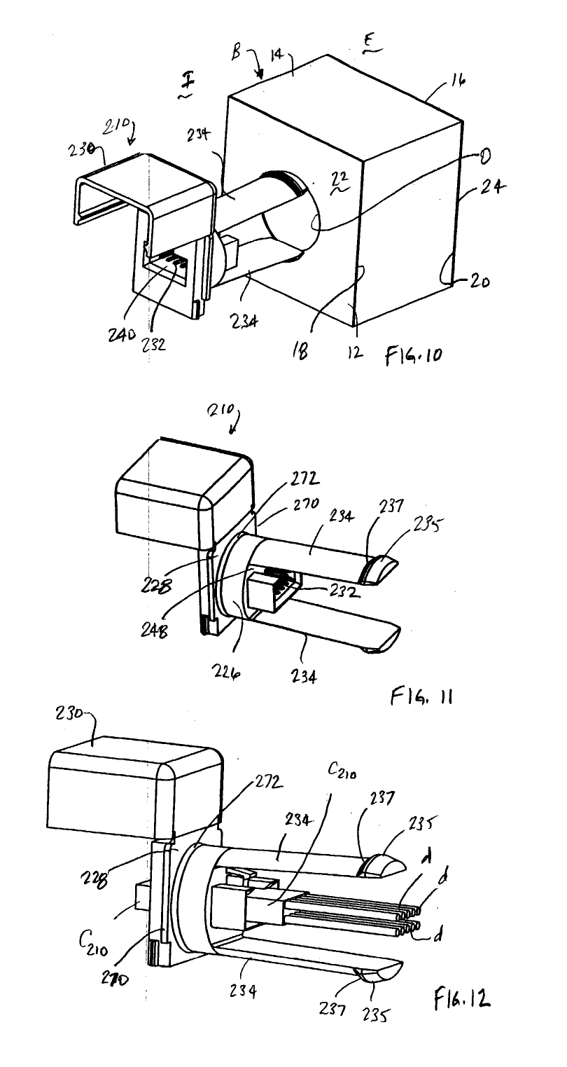

In a current embodiment (referring briefly to FIGS. 6-9), the header 110 can include a seal 164, such as a gasket positioned on the flange rear face 170, such that the gasket 164 is positioned between the flange 128 and the inner shell outer surface 22. Such a seal 164 enhances the environmental barrier between the header 110 and the bulkhead B to further limit or prevent the introduction of warm air from the environment into the conditioned region or conversely to prevent the escape of conditioned air from the conditioned region. The gasket 164 can be adhered to the flange 128 by, for example, an adhesive to assure a seal between the header 110 and the gasket 164 and to assure that the gasket 164 remains properly positioned on the header flange 128.

Referring again to FIGS. 1-5, the body 26 is formed having a hollow, indented central portion defining a cavity 40. As will be appreciated by those skilled in the art, the body 26 defines an environmental barrier between the inside of the refrigerated apparatus and the environs. The electrically conducting pins 32 are positioned in the body 26 and extend between the rear 42 of the body (within the cavity 40) and the front 44 of the body, penetrating the environmental barrier, thus providing an electrical connection across the barrier. In a present embodiment, the pins 32 are molded into the header body 26 (which, in a present embodiment is molded as a unitary element). The body 26 can include one or more interference members 46 extending outwardly from a front face 48 or a rear face 50 of the body 26. The interference members 46, as discussed below assure that a connector C that is mounted to the header 10 is properly electrically connected. That is, the interference members 46 permit only one orientation for mounting the connector C to the header 10.

In a present header 10 the cover 30 is formed as part of the header 10 (again, with the header 10 formed as an unitary, integral member), and is connected to the flange 28 by a living hinge 52. The cover 30 includes a rear wall 54, and top 56 and side 58 walls contiguous with the rear wall 54. The hinge 52 is formed between the top wall 56 and the flange 28. The side walls 58 and flange 28 can include a latching arrangement that secures the cover 30 in the closed position. In a present embodiment, the side walls 58 include barbs or catches 60 that extend along the edges thereof. The barbs 60 are configured to engage the flange 28 at respective side edges, at which lips 62 can be formed, to mate with the barbs 60. The cover 30 thus latches in place when closed.

The present header 10 for electrically connecting devices within, for example, a refrigerated vending machine, can be mated with electrical connectors C that have a plurality of conductors d terminated within a single unit (i.e., terminated at the connector C). One exemplary connector C is that currently available from ITW-Pancon of Bolingbrook, Ill. as MAS-CON® type electrical connectors. In such a connector C, a plurality of conductors d are carried by the connector C so that a single plug-in type module is used to carry out multiple electrical connections. Such a connector C can be formed so that it can be mounted to the bulkhead header 10 (on both sides 42, 44 of the header 10) in only one orientation. In this manner, the proper contacts (and conductors d) within the connector C will be paired or mated with their corresponding proper contacts (and conductors d) in the connector C mounted to the opposing side of the header 10. As seen in FIGS. 2 and 4, this embodiment of the header 10 is configured to receive a single-row, ten-pin connector C on each the inside 42 and outside 44 connections thereof.

FIG. 4 shows such an arrangement with connectors C mounted to both sides 42, 44 of the header 10. As illustrated in FIG. 4, the connector C₄₂ on the inside 42 of the header 10 is a ninety-degree connector C₄₂ such that the conductors d are mounted to the connector C₄₂ ninety (90) degrees relative to the direction at which the connector C₄₂ mounts to the header 10. In this manner, as illustrated in FIG. 5, the cover 30 can be readily closed to cover or protect the connector C₄₂ and conductors d. The cover 30, in addition to providing physical or contact protection to the connector C₄₂ also functions as a drip shield to prevent dripping of condensation onto the connector C₄₂ and into the header electrical connection region, e.g., the cavity 40.

As is best seen in FIGS. 2 and 3, the header interference members 46 prevent incorrectly mounting a connector C to the header 10. Likewise, the header internal cavity 40, can be configured so that the connector C can be inserted into the cavity 40 in only a single orientation, and/or interference members 46 can be formed in the cavity 40 to assure proper connector C orientation.

An alternate embodiment of the bulkhead header 110 is illustrated in FIGS. 6-9. In this embodiment, the header 110 is configured for receipt of a single connector (not shown) having a two-row, five-pin arrangement. The interference member 146 in this embodiment 110 is configured as a channel-shaped element (e.g., three contiguous walls) extending outwardly from the front face 148 of the body 126, within which the pins 132 are positioned. The body 126 can include a connector latch 166 that provides a mechanical lock of the connector to header body 126. This provides additional security against pull-out of the connector from the header 110.

The cover 130 of this embodiment includes an inclined or sloped rear surface 168. This tends to drain any liquid (e.g., condensation) from the header 110, away from the electrical connection region 140 within the header body 126. This embodiment 110 is illustrated with the gasket 164 positioned at the rear face 170 of the flange 128.

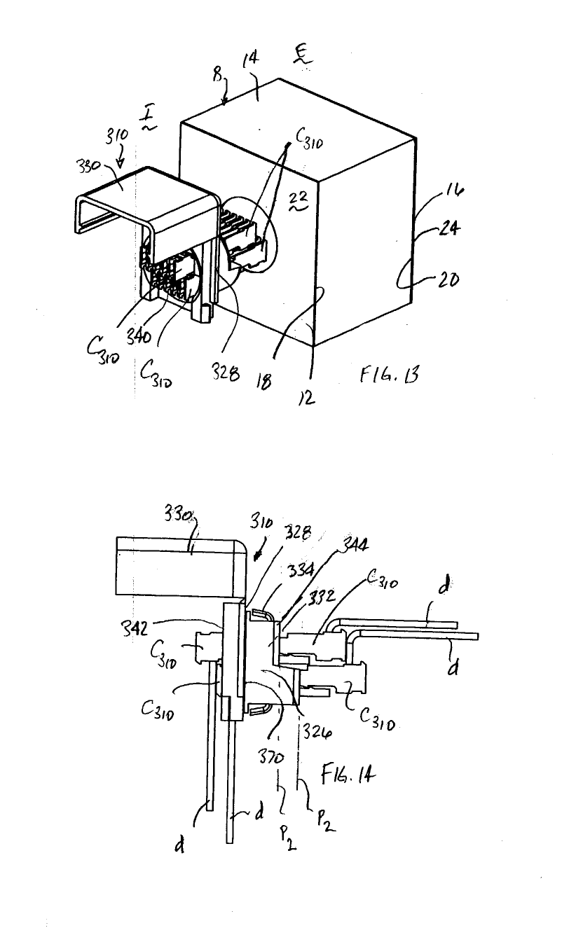

Still another embodiment of the header 210 is illustrated in FIGS. 10-12. In this embodiment 210, the cover 230 is of a rectangular shape (similar to that of FIGS. 1-5). The tangs 234, however, extend from the front face 248 of the body 226 to engage the bulkhead outer shell outer surface 24. Such an arrangement may be used where, for example, it is desired to fully disconnect the header 210 from the bulkhead B. The tangs 234 can include an outwardly extending detent 235 at a free end 236 of each tang 234. Serrations or ridges 237 can be formed at the detents 235 to enhance engagement of the tangs 234 with the bulkhead outer shell 16.

As seen in FIG. 12, in that the tangs 234 are elongated, they provide an additional protecting function for the connector C₂₁₀ and conductors d extending therefrom. This header 210 can be formed for receipt of any connector C configuration, and is shown for use with a single two-row, five-pin connector C₂₁₀ arrangement. The header 210 can include a tapered wall 272 at a transition of the flange 228 to the body 226 to provide a snug fit of the body 226 in bulkhead opening O. This embodiment 210 can also include a gasket (not shown) positioned at the rear face 270 of the flange 228 similar to the embodiment 110 of FIGS. 6-9.

Yet another embodiment 310 of the header is illustrated in FIGS. 13 and 14. This embodiment 310 is configured similar to that of FIGS. 1-5, having a rectangular cover 330 and short, rearwardly extending tangs 334. The front 344 and rear 342 of the body 326 and the internal cavity 340 of the body 326 are configured to receive two standard, single-row five-pin connectors C₃₁₀. As such, two connectors C₃₁₀ are mounted to each the front 344 (outside end) and the rear 342 (inside end) of the header 310.

In this embodiment, the connecting regions for the connectors C₃₁₀ are staggered (i.e., lie in different planes P₁, P₂) from one another to facilitate molding the pins 332 properly in place and to provide an arrangement by which the pairs of connectors C₃₁₀ can be readily mounted to both the front 344 (outside) and rear 342 (inside) of the header 310. As will be appreciated by those skilled in the art, this arrangement provides a ten-pin connection in a relatively compact, easily accessed space. It will also be recognized that this embodiment 310 can include a gasket (not shown) positioned at the rear face 370 of the flange 328 similar to the embodiment 110 of FIGS. 6-9.

As will be readily recognized and appreciated by those skilled in the art, a wide variety of pin configurations, connector configurations, body shapes and the like may be substituted for those shown in the exemplary headers without departing from the true scope and spirit of the prevent invention. It will also be understood that the gasket or seal 164 illustrated in connection with the embodiment 110 of FIGS. 6-9 can be present on each of the headers disclosed herein. All such variations and changes are intended to be within the scope of the present invention and the appended claims.

All patents referred to herein, are hereby incorporated herein by reference, whether or not specifically do so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

What is claimed is:

1. A bulkhead header for electrically connecting electrical connectors on first and second sides of a bulkhead having first and second surfaces and defining an opening therein, the header comprising:
a body configured for insertion into the bulkhead opening and having at least a pair of tangs for engaging the first surface of the bulkhead;
a plurality of pins disposed in the body, the pins extending from a flange side of the header through to a body side of the header; and
a flange integral with the body for resting against the second surface of the bulkhead such that a portion of the bulkhead is engaged between the tangs and flange to secure the header to the bulkhead, wherein the pins provide electrical connection across the first and second surfaces of the bulkhead.

2. The bulkhead header in accordance with claim 1 including a cover connected to the flange for overlying the pins at the flange side of the header.

3. The bulkhead header in accordance with claim 2 wherein the cover is integrally formed with the header and is connected to the flange by a living hinge.

4. The bulkhead header in accordance with claim 2 wherein the cover includes a latch to secure the cover in a closed position overlying the pins at the flange side of the header.

5. The bulkhead header in accordance with claim 4 wherein the cover includes opposing side walls, a top wall and a rear wall, and wherein the hinge is disposed on the top wall and the latch is disposed one or both of the side walls.

6. The bulkhead header in accordance with claim 1 wherein the tangs extend from an end of the body and are oriented outwardly and rearwardly toward the flange.

7. The bulkhead header in accordance with claim wherein the tangs extend rearwardly toward the flange and are spaced from the flange a predetermined distance, the tangs spreading to define an effective circumference that is greater than a distance across the body.

8. The bulkhead header in accordance with claim 1 wherein the tangs extend from an end of the body and are oriented forwardly, away from the flange.

9. The bulkhead header in accordance with claim 8 including a tapered wall at a transition of the flange and the body.

10. The bulkhead header in accordance with claim 1 wherein the body is formed to define a projecting region defining a cavity therein and wherein the projecting region is configured for insertion into the bulkhead opening and wherein the pins are set in the cavity.

11. The bulkhead header in accordance with claim 1 including an interference member disposed at about the pins to permit connecting a connector to the pins in only one orientation.

12. The bulkhead header in accordance with claim 1 including ten pins arranged in a single row of ten pins.

13. The bulkhead header in accordance with claim 1 including ten pins arranged in two rows of five pins each.

14. The bulkhead header in accordance with claim 13 wherein a first row of pins is in a first plane and a second row of pins is in a second plane different from the first plane.

15. The bulkhead header in accordance with claim 1 including a seal disposed on the flange to abut the bulkhead.

16. A bulkhead header for electrically connecting electrical connectors on first and second sides of a bulkhead having first and second surfaces and defining an opening therein, the header comprising:
a body configured for insertion into the bulkhead opening;
a plurality of electrically conducting pins disposed in the body and extending through the body from a first side of the body to a second side of the body; and
first and second bulkhead securing elements for engaging the first and second surfaces of the bulkhead to secure the header to the bulkhead by sandwiching a portion of the bulkhead therebetween.

17. The bulkhead header in accordance with claim 16 wherein the first bulkhead securing element is at least one flexible finger configured to overlie a portion of the bulkhead first surface adjacent the opening.

18. The bulkhead header in accordance with claim 17 wherein the second bulkhead securing element is a planar surface formed integral with and extending outwardly from the body.

19. The bulkhead header in accordance with claim 18 including a seal disposed on the planar surface.

20. A molded bulkhead header for electrically connecting electrical connectors on first and second sides of a bulkhead having first and second surfaces and defining an opening therein, the header comprising:
a body configured for insertion into the bulkhead opening and having a pair of opposingly oriented tangs for engaging the first surface of the bulkhead;
a plurality of pins disposed in the body, the pins extending from a flange side of the header through to a body side of the header;
a flange integral with the body for resting against the second surface of the bulkhead such that a portion of the bulkhead is engaged between the tangs and flange to secure the header to the bulkhead, wherein the pins provide electrical connection across the first and second surfaces of the bulkhead; and
a drip shield formed integral with the flange for overlying the pins at the flange side of the header, the drip shield being connected to the flange by a living hinge, and including a latch for retaining the drip shield in a position overlying the pins at the flange side of the header.

21. The molded bulkhead header in accordance with claim 20 wherein the tangs extend from an end of the body and are oriented outwardly and rearwardly toward the flange, the tangs extending rearwardly toward the flange and being spaced from the flange a predetermined distance, the tangs spreading to define an effective circumference that is greater than a distance across the body.

22. The molded bulkhead header in accordance with claim 20 including an interference member disposed at about the pins to permit connecting a connector to the pins in only one orientation.

23. The molded bulkhead header in accordance with claim 20 including a seal disposed on the flange for abutting the bulkhead.
